(19) United States
(12) Patent Application Publication
(10) Pub. No.: US 2014/0095314 A1
(43) Pub. Date: Apr. 3, 2014

(54) TIME POST SYSTEM AND METHOD FOR ADVERTISING

(71) Applicant: Michael-Charles Nahounou, Bristol, CT (US)

(72) Inventor: Michael-Charles Nahounou, Bristol, CT (US)

(21) Appl. No.: 14/039,903

(22) Filed: Sep. 27, 2013

Related U.S. Application Data
(60) Provisional application No. 61/707,906, filed on Sep. 29, 2012.

(51) Int. Cl. G06Q 30/02

(52) U.S. Cl. CPC G06Q 30/0272; G06Q 30/0273
USPC 705/14.58; 705/14.68

(57) ABSTRACT

A system and method allows anyone to advertise using the language and attributes of a standard time clock. The present invention allows anyone to visit a website, purchase a fixed length of time (typically from 15 seconds to 6 minutes) to represent duration of one period of display of an advertisement, and specify frequency of periods of display of the advertisement within allowed parameters. The system and method maintains freshness of advertisements by limiting one particular advertisement to be displayed no more than once per period. The date or dates of display may also be specified. The pricing structure of the present invention charges a fixed price based on the specified duration of the advertisement. The limitations also level the playing field preventing large entities from monopolizing the entire duration for advertisements.

Pursuant to 35 USC §119(e), this application claims the benefit of U.S. Provisional Patent Application No. 61/707,906 filed on Sep. 29, 2012.

### FIELD OF THE INVENTION

A system and method allows anyone to advertise using the language and attributes of a standard time clock. The present invention allows anyone to visit a website, purchase a fixed length of time (typically from 15 seconds to 6 minutes) to represent duration of one period of display of an advertisement, and specify frequency of periods of display of the advertisement within allowed parameters. The system and method maintains freshness of advertisements by limiting one particular advertisement to be displayed no more than once per period. The date or dates of display may also be specified. The pricing structure of the present invention charges a fixed price based on the specified duration of the advertisement. The limitations also level the playing field preventing large entities from monopolizing the entire duration for advertisements.

### DESCRIPTION

### Background of the Invention

The present invention relates to advertising systems and methods and, more particularly, to a novel system and method for scheduling and displaying an advertisement.

In the cutthroat field of Digital Out-Of-Home (DOOH) advertising, small start-up companies often suffer hardship when competing with larger, wealthier companies. The present invention serves to systematically level the playing field to allow for more affordable and equitable DOOH advertising for anyone desiring to advertise.

There is a need for a system and method for allowing anyone access to affordable advertisement space and the ability to specify duration and date of a particular advertisement with cost tied only to the length chosen. The claimed invention serves to maintain freshness of exhibited advertisements by limiting the amount of times a particular advertisement is displayed per period. The claimed system and method also allows anyone to schedule advertisements for a fixed cost per duration limited by maximum purchase durations. These features help fulfill needs in the competitive field of advertising.

### SUMMARY OF THE INVENTION

In one aspect of the present invention, a processing device which features programming code for advertising at least one advertisement is disclosed. The programming code contains multiple code sequences. One particular code sequence allows a user to specify a fixed length of time for display of said advertisement. Another code sequence allows said user to specify frequency of said advertisement wherein said advertisement is displayed, on a digital medium, no more than once per period, with a typical period being one hour. This serves to maintain freshness of a displayed advertisement and prevent monopolization of the particular medium. In addition, one code sequence allows said user to specify date or dates of display of said advertisement. Another code sequence calculates cost of said advertisement by charging said user a fixed price per unit of time specified with consideration for the number of periods in which said advertisement will be displayed and for the time remaining in a current calendar year. Other code sequences operate to allow said user to upload an image file or files of an advertisement for publication, proof said file or files and check for duplication with other uploaded file or files, alerting an administrator and said user of any violations of programmed restrictions regarding content or duplication. In addition, a code sequence allows said user to specify geographic locale or locales for display of said advertisement and receive map coordinates of said geographic locale or locales, said map coordinates generated by another code sequence. Another code sequence allows said user to transmit said advertisement to live digital displays. In addition, a code sequence allows said advertisement to be broadcast over multiple mediums and display sizes with automatic adjustment of said advertisement to appropriately fit the display size.

In another embodiment of the present invention, disclosed is a method for advertising at least one advertisement. The method receives, from a processing device, an input specifying a fixed length of time for display of said advertisement from a user. The method receives an input specifying frequency of said advertisement from said user wherein one advertisement is displayed, on a digital medium, no more than once per period, with a typical period being one hour. In addition, the method receives an input specifying date or dates of display of said advertisement requested from said user. The method calculates cost of said advertisement by charging said user a fixed price per unit of time specified with consideration for the number of periods in which said advertisement will be displayed and for the time remaining in a current calendar year. The method allows said user to upload an image file or files of an advertisement for publication, proofs said file or files and checks for duplication with other uploaded file or files, and alerts an administrator and said user of any violations of content or duplication restrictions. The method also receives an input specifying geographic locale or locales for display of said advertisement and, after generating map coordinates of said geographic locale or locales, transmits said map coordinates to said user. The method receives an input specifying medium or mediums of publication and enables said user to transmit said advertising content to available live digital displays of varying display sizes with automatic adjustment of said advertisement to appropriately fit the display size. The method also allows an administrator to display said advertisement on a website of said administrator.

These and other features, aspects and advantages of the present invention will become better understood with reference to the following drawings, description and claims.

### BRIEF DESCRIPTION OF THE DRAWINGS

FIG. 1 represents a flowchart demonstrating operation of a preferred embodiment of the claimed system and method.

FIG. 2 is a continuation of the flowchart represented in FIG. 1.

FIG. 3 is a continuation of the flowchart represented in FIG. 2.

FIG. 4 represents a configuration of one embodiment of a Toc based on the different types of Tics.

FIG. 5 represents the options available to a user in terms of Tics and frequency in one embodiment of the present invention.

FIG. 6 represents the Calendar Type periods available to a user when specifying frequency in one embodiment of the present invention.

FIG. 7 represents Toc and Tic organization wherein the claimed system and method would schedule a Tic according to Calendar Type period in one embodiment of the present invention.

FIG. 8 represents two charts demonstrating the cost structure of advertising using the claimed system and method of one embodiment of the present invention.

FIG. 9 represents two inventory charts illustrating daily and annual inventory logs in one embodiment of the present invention.

FIG. 10 represents two revenue charts illustrating income logs in one embodiment of the present invention.

### DETAILED DESCRIPTION OF THE INVENTION

The claimed invention is a system and method for advertisement that embodies a simulation of the operation of a standard clock. This detailed description sets out the best mode of executing certain embodiments of the claimed invention. Each second, minute, and hour is attributed to a space on the advertising scheme. Accordingly, by the end of the day, each second, minute, and hour may be filled with an advertisement. Users have options for the way in which they want their advertisements to be displayed. During the course of operation of the claimed invention said users will have the option to change the duration and frequency of advertisement display. This is accomplished while using the language and attributes of a standard time clock. After a user chooses these fields, the user will receive a competitive rate for the advertising and the same rate that any advertiser would pay for the same duration of advertisement for the given medium chosen.

To accomplish these tasks, the claimed system and method relies on complex algorithms and a processor for execution of user requests according to those algorithms. In addition, the claimed system and invention relies on a display platform in order to fully complete the process of advertising. Without any one of the complex algorithms, processor, and display platform, the claimed system and method would not operate.

Advertisements in this system and method are defined as Tics and Tocs. A “Tic” as used herein, is an advertisement on a given digital advertising medium for a specific duration. A “Toc” is one complete set of advertisements that fill a durational period: in one embodiment, four different advertisements by four different advertisers on a given digital advertising medium make up a specific longer duration. Tics may be of different durations, but always equal to or shorter in duration than a Toc. The duration of a Toc is equal to the sum of the duration of one or more Tics. In traditional advertisement lingo and in one embodiment herein, a Tic is akin to one advertisement and a Toc is akin to a two-minute advertisement slot. In this example, two fifteen second Tics, one thirty second Tic and one one-minute Tic could equal a Toc.

Users will be able to conduct a scheduling system by using claimed system and method-modeled digital signage systems and Internet mediums online. In order to purchase an advertising slot (Tic or Toc) for mediums using the claimed system and method, users can follow the online registration procedures via a website or local specialized Time Post office. At these portals, companies can determine the type of Tic, the frequency of display, or the Calendar Type period. The claimed system and method allows for administrators to process payment online. In one embodiment, a user would be able to start purchasing advertising slots in the month immediately preceding the year which contains said advertising slots. For example, if a user wanted to purchase the advertising slot of February 2017, s/he would be able to complete the act of purchasing said advertising slot in December 2016.

The claimed system and method algorithmically determines availability based on variable duration and frequency of ads, manages user content, and deals with inventory management for each digital display.

In a preferred embodiment, there are 4 Tics in every Toc. Each Toc lasts exactly 120 seconds (2 minutes). A single Toc contains one 60-second Tic, one 30-second Tic, and two 15-second Tics. The four Tics are grouped in Toc [2-minute] intervals. A digital advertising medium utilizing the claimed system and method can advertise a maximum of 30 Tocs per hour. This extrapolates to 2,880 Tics and 720 Tocs in 24 hours.

Along with the traditional time clock language of “Tic” and “Toc,” this system and method will additionally include similar language to label time intervals. The labels include Whole Minute, Half Past, and Quarter Past. The claimed system and method uses this traditional language, which usually signifies a given time of the hour, as labels for the various types of Tics, or the specific types of advertisements. For example, a “Whole Minute” advertisement is an alternative name for a 60-second Tic. A “Half Past” advertisement is an alternative name for a 30-second Tic. A “Quarter Past” advertisement is an alternative name for a 15-second Tic.

A user can have more than one advertisement instituted in the claimed system and method, but, in a preferred embodiment, the claimed system and method maintains freshness of advertisements by limiting each advertisement to a maximum of 1 minute per hour per day. In an alternative embodiment, the cumulative display time of one advertisement may reach 6 minutes, or 3 Tocs, per hour per day. With 120 Tics in each hour, up to 120 different businesses can be advertised in one hour in the claimed system and method. This fulfills a need of freshness in advertising and also serves to level the playing field among businesses desiring to advertise by preventing monopolization due to one user buying up all available Tics and/or Tocs.

The claimed system and method presents several distinct and surprising advantages from advertising concepts currently known in the art. Currently, standard digital billboards typically display an average of eight advertisers per board per day. The same eight advertisements typically circulate at 8-second intervals every 64 seconds per day. The shortest available time for an advertisement using the claimed system and method, 15 seconds, is nearly twice the duration of the maximum available time on a standard digital billboard [8 seconds]. Furthermore, the maximum available time for an advertisement using the claimed system and method is an entire minute [60 seconds]. Additionally, the claimed system and method limits advertisers to a purchase of one Tic per hour assuring that no one advertiser may monopolize one advertising medium. In one embodiment, there will be a maximum of 120 different advertisers per hour, achieved when each of the thirty Tocs of one hour features four distinct advertisers purchasing a separate Tic. While this may be against normal sales logic of wanting to sell out as quickly as possible even if that means selling all time slots to the first taker, the end result is fresh ads with less repetition making them more watched and hence more valuable and more desired by advertisers. Therefore, in one year, a single digital display utilizing the claimed system and method in one embodiment can display a total of 43,800 advertisers, as compared with 2,920 on a single standard digital display. By keeping the price fixed per duration, any and all advertisers may compete on a level playing field with all other advertisers.

The claimed system and method utilizes a sophisticated scheduling system for organizing all advertisements. Using a process called “Calendar Typing,” in one embodiment, the claimed system and method disseminates advertisements at fixed intervals throughout a year. A user may purchase advertisement space using up to six different Calendar Type periods, which include days, weeks, months, quarters, semi-annuals, and years.

In one embodiment of the present invention, each of the six Calendar Type periods signifies the fixed length of time an advertisement campaign will run. For example, a “day” Calendar Type period will run once every hour for up to one day. A “week” Calendar Type period will run once every hour for up to one week. A “month” Calendar Type period will run once every hour for up to one month. A “quarter” Calendar Type period will run once every hour for up to one 3-month period. A “semi-annual” Calendar Type period will run once every hour for up to one 6-month period. A “year” Calendar Type period will run once every hour for up to one year. If a user desires to display an advertisement in a year past the current calendar year, said user will have to purchase advertisement space for a future year or years. If a specified Calendar Type period extends beyond December 31 of a current year, the advertisement will cease running at the start of the new year regardless of the specified Calendar Type period. For example, if a user chooses a “quarter” Calendar Type period to start on November 15 the claimed system and method would preclude the advertisement from running after December 31 even though the selection of a “quarter” Calendar Type would ordinarily instruct the claimed system and method to display the advertisement for 3 months.

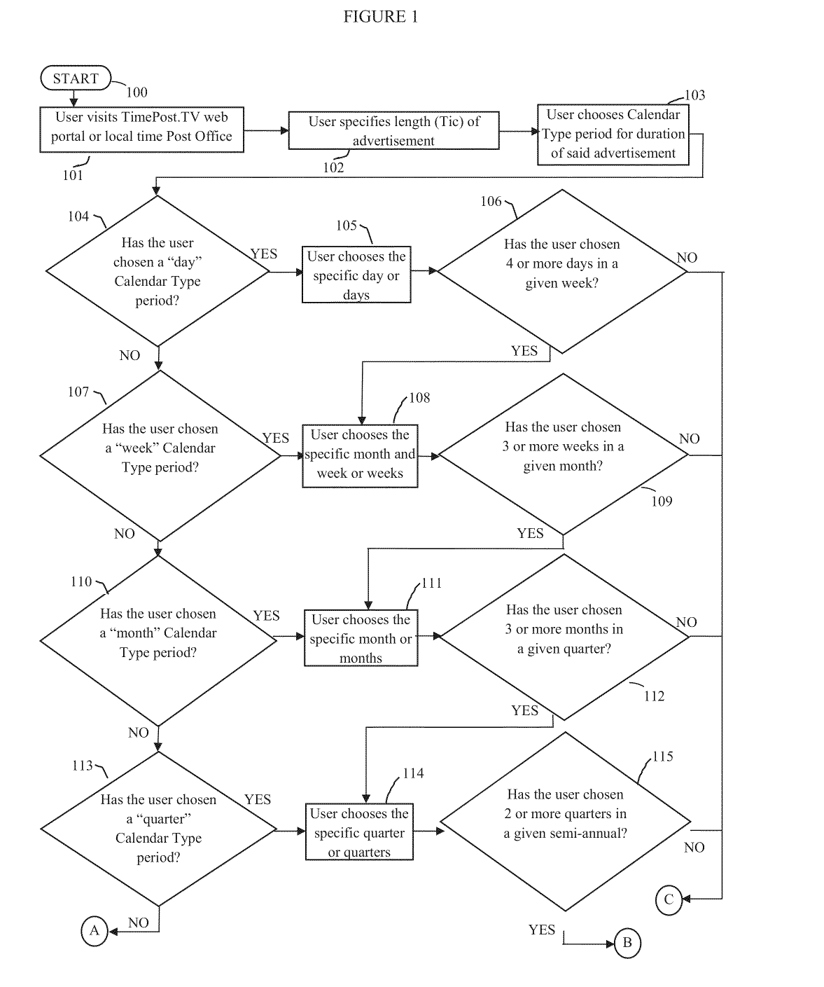

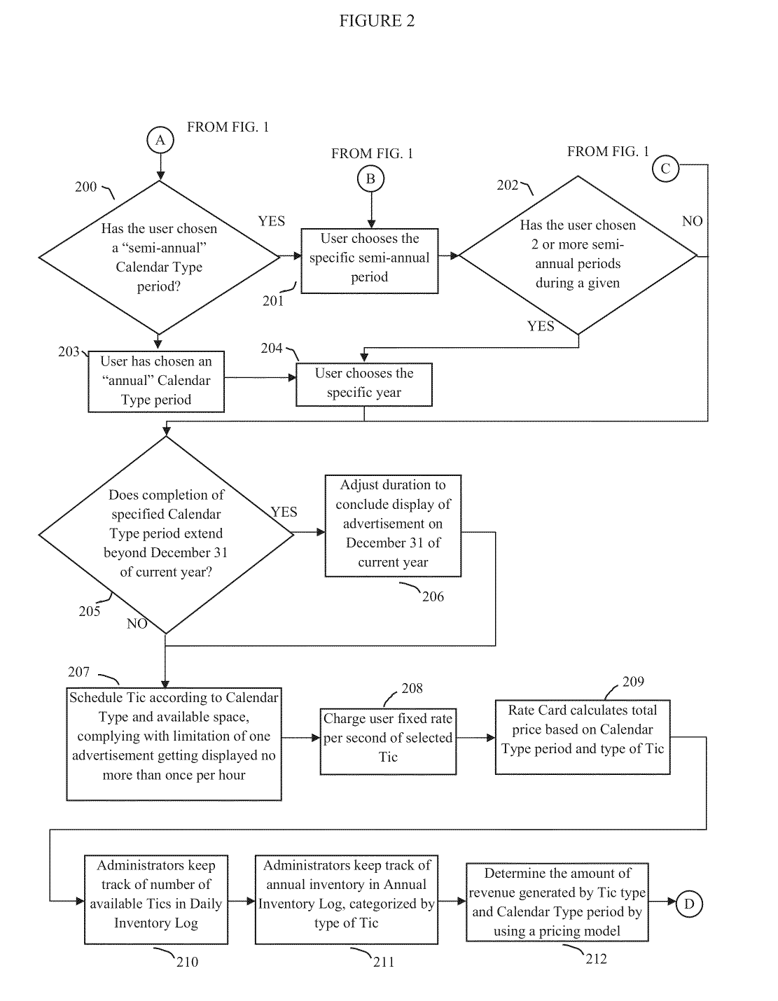

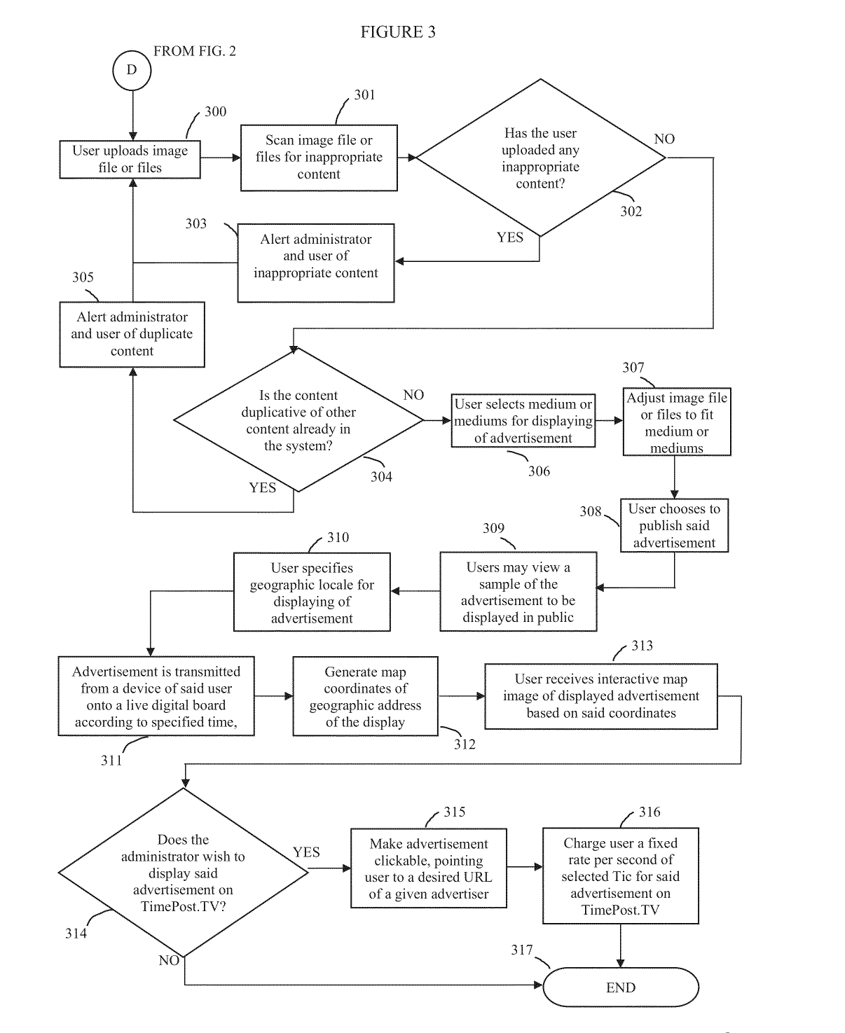

FIG. 1, FIG. 2, and FIG. 3 represent the operation of one embodiment of the claimed system and method. At the start 100 of the operation, a user must visit 101 a web portal or office and select 102 the length of the Tic. Said user must then choose 103 the frequency of said Tic by specifying a Calendar Type period which corresponds to the amount of iterations of said advertisement. For example, if an advertiser chooses a 30-second “day” Tic, the advertisement or Tic will appear on a digital display once every hour for 24 hours, lasting 30 seconds each.

For “day” Calendar Type periods 104, the user chooses 105 specific day or days. For “week” Calendar Type periods 107, the user chooses 108 a month and then specific week or weeks. For “month” Calendar Type periods 110, the user chooses 111 specific month or months. For “quarter” Calendar Type periods 113, the user chooses 114 a specific 3-month period. For “semi-annual” Calendar Type periods 200, the user chooses 201 a specific 6-month period. “Year” Calendar Type periods 203 are available for selection shortly before the intended year. The user chooses 204 a specific year for a “Year” Calendar Type period.

An advertiser may only select one Calendar Type period per advertisement. There are also limitations on purchasing Calendar Type periods. If an advertiser intends to run the same advertisement several times using more than the allowed time limit on the Calendar Type period in question, the advertiser must upgrade to the higher Calendar Type period. For example, if an advertiser wants to run an advertisement using four or more “day” Calendar Type periods during a given week, s/he must upgrade to the “week” Calendar Type period. Therefore, a company is allowed to purchase up to a maximum of three units of the same “day” Calendar Type period for a given week. If a company has reached its maximum allowance and wants to purchase four or more of the same “day” Calendar Type period during a given week, it must upgrade to the higher unit.

The maximum number of units allowed for each Calendar Type period include: three days during a given week for the “day” Calendar Type period 106, two weeks during a given month for the “week” Calendar Type period 109, two months during a given quarter for the “month” Calendar Type period 112, one quarter during a given semi-annual for the “quarter” Calendar Type period 115, and one semi-annual during a given year for the “semi-annual” Calendar Type period 202. Each Calendar Type period is considered a unit of inventory on hand at midnight on January 1 of each year. Therefore, in order to determine whether there is space available for an advertisement the system and method inspects current inventory. The claimed system and method checks 205 whether completion of the specified Calendar Type period extends beyond December 31 of a current year. If so, it adjusts 206 duration of display of said advertisement to conclude on December 31 of the current year. The claimed system and method then schedules 207 the appropriate Tic based on available space and complying with the limitation that the claimed system and method will display one particular advertisement only once per hour.

The pricing model known in the advertising art using both digital and static mediums is based on the concept of CPM (Cost Per Mille, or cost per thousand), defined as price per 1,000 impressions, or people. This rate is determined by the market and fluctuates depending on the amount of people in said market. The CPM is a tool that advertisers and media buyers commonly use to compare different advertising media, leveling the playing field between them. CPM is a measurement of how much a medium costs per 1,000 impressions. Since most advertisers want to make efficient advertising buys, the CPM is the tool used to maximize profits.

By contrast, the pricing model in one embodiment of the claimed system and method is based on the concept of CPT (Cost Per Tic). CPT is a fixed rate. The claimed system and method charges 208 users a fixed rate based on based on a cent per second ratio. In one embodiment, each advertisement will cost $0.0333, or 3.33 cents, per second of advertisement time. For example, a 60-second advertisement is priced at the time rate of $0.0333 per second, or $2.00 for the full 60 seconds. The 30-second and 15-second advertisement slots are also priced at the same time rate of $0.0333 per second. This equates to $0.50 CPT total for each 15-second Tic, a $1.00 CPT total for each 30-second Tic, and a $2.00 CPT total for each 60-second Tic. In an alternative embodiment, a multiplier could be applied to the fixed price to account for advertising high-end markets.

The claimed system and method also generates 209 a Rate Card, which is a total price of what each advertiser pays for a Tic campaign. The calculation depends on the Calendar Type period and the type of Tic. For example, if an advertiser chooses a “Whole Minute” “day” Tic for an advertisement campaign, said advertiser will be paying $48.00 for said advertisement campaign.

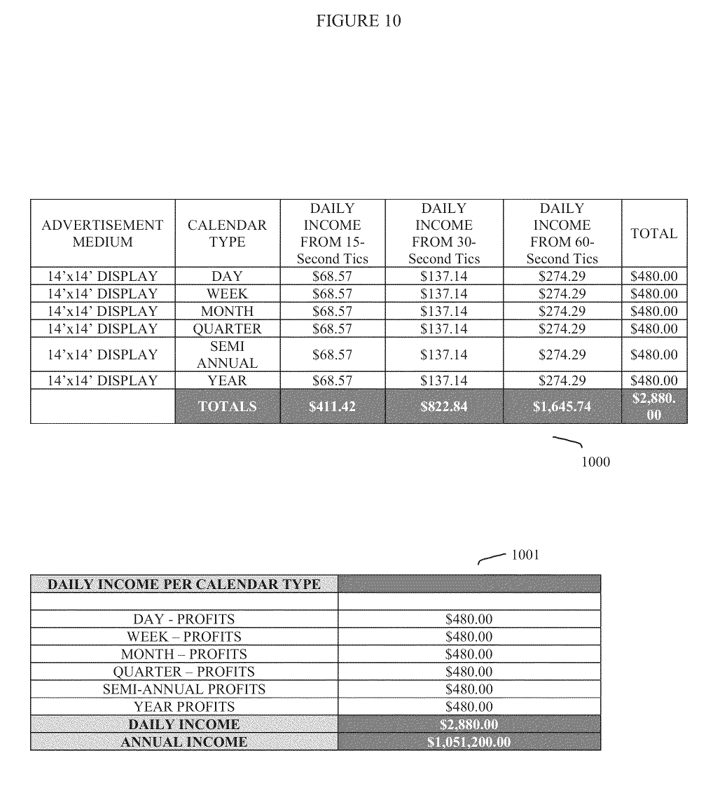

The claimed system and method also allows for administrators to keep track 210 of available Tics via a daily inventory log. Administrators are also able to keep track 211 of the annual inventory via an annual inventory log. The number of Calendar Type periods sold is categorized by type of Tic. The administrators will be able to determine, for example, how many 60-second “day” Calendar Type periods are available for the year or how many 15-second “quarter” Calendar Type periods are sold for the year. The administrators can use the logs to determine 212 the amount of revenue generated per day and per year, as illustrated by the charts in FIG. 10. The chart figures will be calculated by a pricing model based on Tic type and Calendar Type period.

After a user uploads 300 an image file or files as part of an advertisement to be displayed, the claimed system and method allows 301 for content-proofing so as to ensure only appropriate material is published. The claimed system and method includes an image-filtering component integrated with algorithms and proxy servers to scan 302 images for inappropriate content, spyware, and malware. An administrator can also scan the images for inappropriate content. The claimed system and method alerts 303 an administrator and the user of any content not suitable for public viewing. This content-proofing feature can also be utilized to insure that a user is not uploading the same advertisement under a different name and/or user name in an attempt to undermine the freshness and non-monopolization goals described herein. The claimed system and method uses algorithms and proxy servers to scan 304 for duplicate images from different users using the same Internet Protocol address. The claimed system and method uses a point-based algorithm for detecting and discovering content within user-uploaded images. The claimed system and method compiles a repository of images. When comparing images, the claimed system and method assigns points for the common elements of the image. The claimed system and method will make the duplication determination based on a cumulative point-score. Once a score reaches a threshold amount the claimed system and method will alert 305 an administrator and the user of the presence of duplicate content.

The invention is also novel because of its ability to broadcast over multiple mediums and digital displays of all sizes. Said user may select 306 a medium or mediums for displaying said advertisement. For example, using an image rendering unit, the claimed system and method can turn a tablet into a digital display and immediately send advertising content to said tablet. The claimed system and method allows the user to upload various forms of image files (for example and without limitation, .jpg, .png, .gif, or .bmp) and then adjusts 307 them to fit on the user-selected medium. For example, a user may upload a 1400×1400-pixel photo for digital display which the system will automatically adjust to fit the size of the medium for said digital display. Additionally, the user could use said photo for another digital display that measures at 700×700 pixels and the same adjustment process would occur. Also, the system will allow an embed code from self-service video platforms. The claimed system and method can display the advertisement photo for the specified time interval.

Once the user chooses 308 to publish uploaded content, the claimed system and method can immediately publish the content without technical lag time. In addition, the claimed system and method allows users to view 309 a sample of the advertisement before it is posted online.

Users can specify 310 the geographic locale for displaying of an advertisement. The claimed system and method is technologically unique as a self-service platform that enables a user to transmit an advertisement to live digital display boards that range in size, style and shape. Display mediums can include smart phones, tablets, or any mobile device with internet connectivity, small- to jumbo-size digital displays alike. Once the user specifies the locale and medium, the claimed system and method transmits 311 the advertisement for display.

In addition, the user will have an interactive map image of the selected digital display or displays in which the advertisements will be featured. The map is generated 312 by the latitude and longitude coordinates provided by the address of the digital display or displays. The user will be able to view 313 the interactive map image based on the coordinates. In an alternative embodiment, administrators would be able to arbitrarily select 314 an advertisement for display on the home page of the website TimePost.TV. The advertisement posted on the home page of the TimePost.TV website would be 315 clickable and would point to a desired URL of a given advertiser. For an advertisement posted on the home page of the website the cost per tic 316 would be $0.01 per second. This equates to $0.15 CPT total for each 15-second Tic, a $0.30 CPT total for each 30-second Tic, and a $0.60 CPT total for each 60-second Tic. This concludes 317 one operation of the claimed system and method.

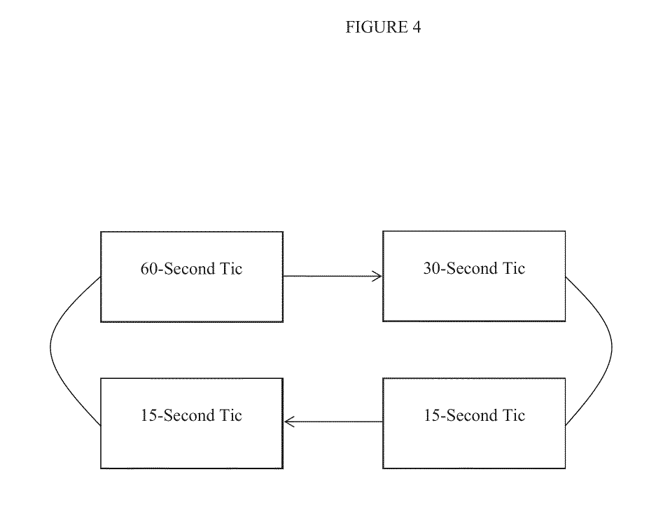

FIG. 4 represents the configuration of one embodiment of a Toc based on the different types of Tics. As previously described, in one embodiment, there are 4 Tics in every Toc. Each Toc lasts exactly 120 seconds. In one embodiment, a single Toc contains one 60-second Tic, one 30-second Tic, and two 15-second Tics.

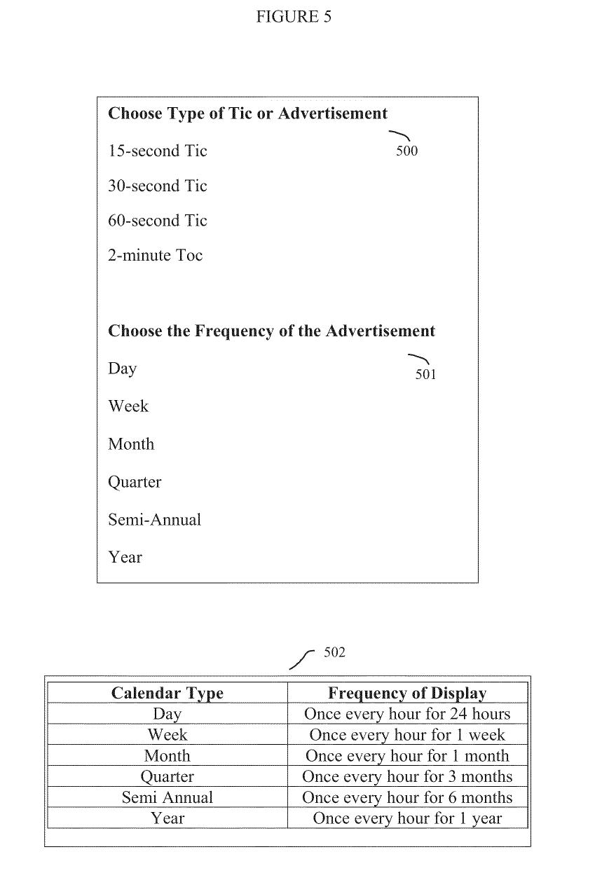

FIG. 5 represents the options available to a user of one embodiment of the claimed system and method in terms of Tics and frequency. The user may choose 500 from one of three different types of Tics: 15-second, 30-second, and 60-second, to specify fixed duration of an advertisement. The user may choose 501 from one of six different Calendar Type periods to specify frequency of display. The exact periods of display based on frequency are illustrated 502 in the chart of FIG. 5.

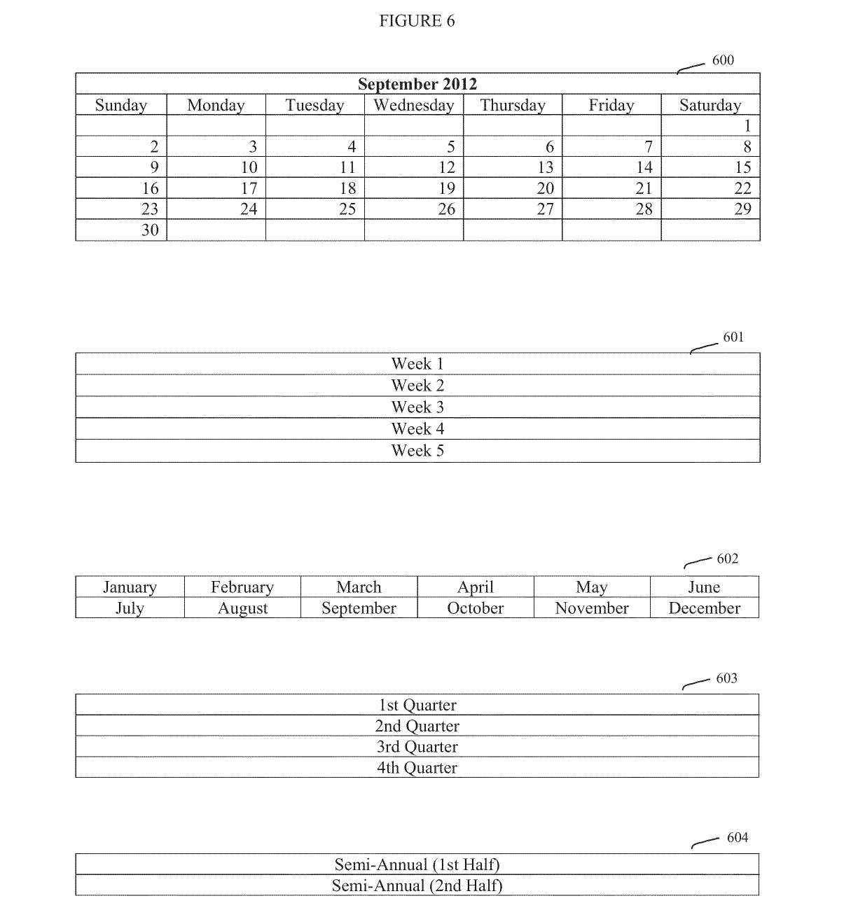

FIG. 6 represents five of the Calendar Type periods available to a user of one embodiment of the claimed system and method when specifying frequency. For a “day” Calendar Type period, the user chooses 600 the specific day or days for display. For a “week” Calendar Type period, the user chooses 601 the specific month and then week or weeks for display. For a “month” Calendar Type period, the user chooses 602 the specific month or months for display. For a “quarter” Calendar Type period, the user chooses 603 the specific quarter for display. For a “semi-annual” Calendar Type period, the user chooses 604 the specific semi-annual period for display.

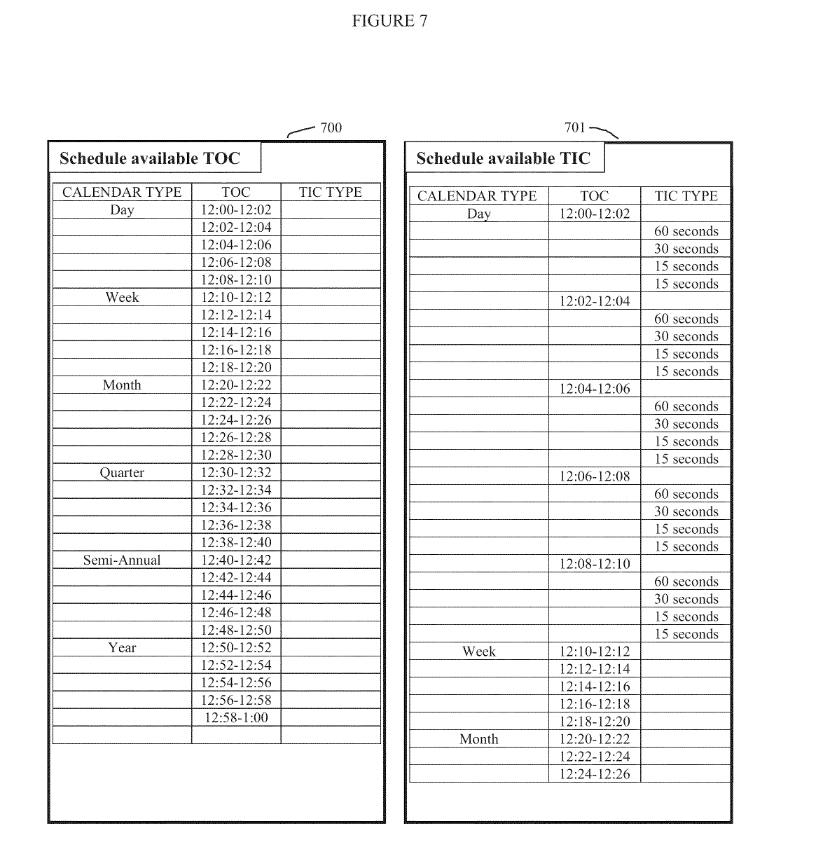

FIG. 7 represents Toc and Tic organization in one embodiment of the claimed system and method wherein the claimed system and method would schedule a Tic according to Calendar Type period. First the claimed system and method schedules 700 a Toc for the user based on specified Calendar Type period. After scheduling a Toc the claimed system and method proceeds to schedule 701 a Tic within a Toc for display. The chart on the right in FIG. 7 demonstrates the Tic and Toc menu for a “day” Calendar Type period.

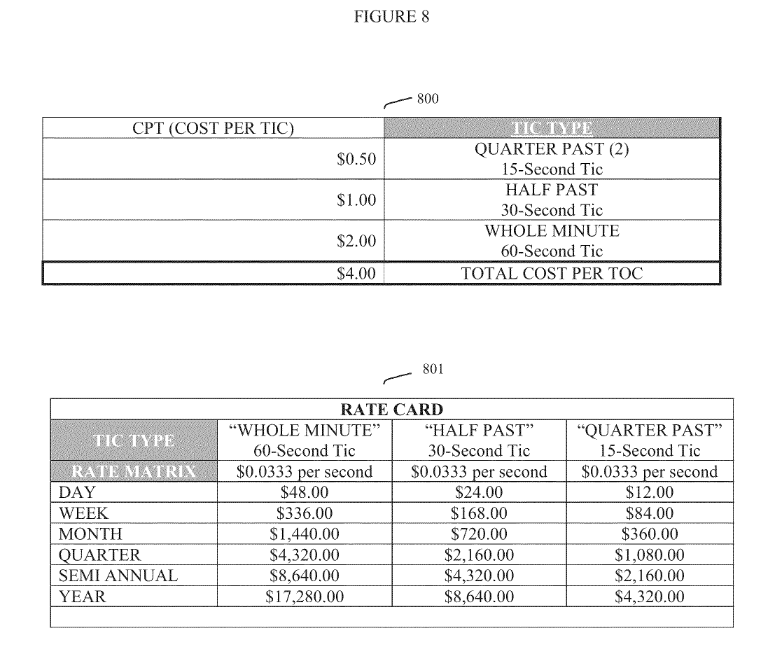

FIG. 8 represents two charts demonstrating the cost structure of advertising using one embodiment of the claimed system and method. The first chart in FIG. 8 demonstrates 800 the implementation of a fixed cost of $0.0333, or 3.33 cents, per second of display time. The second chart in FIG. 8 demonstrates 802 a Rate Card which is generated by multiplying the seconds in the Tic with the amount of hours pertaining to each individual Calendar Type period. Since the claimed system and method limits the display of one advertisement to once per hour, the costs will not exceed the prices listed in the Rate Card.

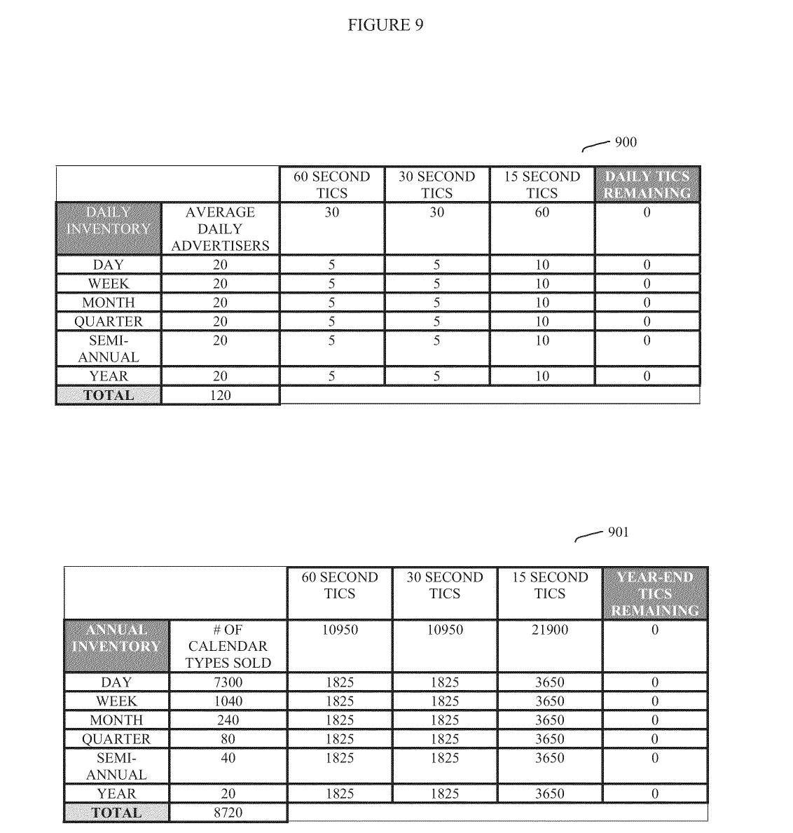

FIG. 9 represents two inventory charts illustrating daily and annual inventory logs of one embodiment of the claimed system and method. The first chart illustrates 900 an exemplary demonstration of advertisers per day with sample numbers per Tic and per Calendar Type period. The second chart illustrates 901 an entire year's worth of Tics and Calendar Type periods sold. The claimed system and method logs the information and administrators are able to view the logs.

FIG. 10 represents two revenue charts illustrating income logs of one embodiment of the claimed system and method. The first chart illustrates 1000 a pricing model which administrators can use to determine the amount of revenue generated by Tic and Calendar Type period. Another chart illustrates 1001 how administrators can calculate daily and annual income based on profits per Calendar Type period.

1. A system for displaying at least one advertisement, comprising:
a processing device;
programming code for displaying said advertisement using said processing device;
said programming code allowing a user to specify fixed length of time for displaying said advertisement;
said programming code allowing said user to specify frequency of and length of time said advertisement will be queued for display, on a digital medium, wherein said advertisement may be displayed no more than once per fixed durational period;
said programming code allowing said user to specify date or dates by choosing a fixed unit or units of time for duration of display of said advertisement; and
said programming code calculating cost of said advertisement by charging said user a fixed price per said fixed length of time.

2. The system of claim 1, further comprising programming code which adjusts said length of time said advertisement will be queued for display if said user specifies a fixed unit of time for duration of display longer than said time remaining in a current year.

3. The system of claim 1, further comprising programming code which adjusts said fixed price based on time remaining in a current year if said user specifies a fixed unit of time for duration of display longer than said time remaining in a current year.

4. The system of claim 1, further comprising programming code which imposes restrictions on specified duration of display by compelling said user to choose a longer said fixed unit of time for duration of display if specified duration of display exceeds programmed allowable maximum of said fixed unit of time for duration of display.

5. The system of claim 1, further comprising programming code to calculate total cost using said fixed price, said fixed length of time, and said specified frequency.

6. The system of claim 1, further comprising programming code to record user-specified lengths of time and user-specified frequency in a daily inventory log.

7. The system of claim 1, further comprising programming code to record user-specified lengths of time and user-specified frequency in an annual inventory log.

8. The system of claim 1, further comprising programming code to record generated revenue using bases of user-specified lengths of time and user-specified frequency.

9. The system of claim 7, further comprising programming code to allow user to upload at least one image file.

10. The system of claim 9, further comprising programming code to proof said at least one image file.

11. The system of claim 10, further comprising programming code to compare said at least one image file with at least one image file previously uploaded.

12. The system of claim 11, further comprising programming code to alert an administrator and said user of violations of programmed restrictions of content of said at least one image file.

13. The system of claim 12, further comprising programming code to allow said user to select at least one medium for displaying said advertisement and adjust said at least one image file to fit in said at least one medium.

14. The system of claim 12, further comprising programming code to allow said user to specify geographic locale or locales for display of said advertisement.

15. The system of claim 12, further comprising programming code to allow said advertisement to be transmitted from a device of said user to a digital display.

16. The system of claim 15, further comprising programming code to generate map coordinates of said geographic locale or locales of said digital display of said advertisement.

17. The system of claim 16 further comprising programming code to transmit an interactive map image displaying said map coordinates to said user.

18. A method for advertising at least one advertisement, the method comprising the steps of:
receiving, from a processing device, an input specifying fixed length of time of said advertising content from a user;
receiving an input specifying frequency of and length of time said advertisement will be queued for display, on a digital medium, wherein said advertisement may be displayed no more than once per fixed durational period;
receiving an input specifying date or dates by choosing a fixed unit or units of time for duration of display of said advertisement; and
calculating cost of said advertising content by charging said user a fixed price per said fixed length of time.

19. The method of claim 18 further allowing an administrator to display said advertisement on a website of said administrator.
